(19) United States
(12) Patent Application Publication
(10) Pub. No.: US 2008/0203329 A1
(43) Pub. Date: Aug. 28, 2008

(54) Method and devices to control global warming

(76) Inventor: Charles Albert Cody, Nashville, IN (US)

Correspondence Address: Charles A. Cody, 3247 Polecat Ridge RD, Nashville, IN, 47448-9144, US

(21) Appl. No.: 12/072,645

(22) Filed: Feb. 27, 2008

Related U.S. Application Data
(60) Provisional application No. 60/903,870, filed on Feb. 28, 2007.

(51) Int. Cl. G21F 1/00

(52) U.S. Cl. 250/515.1

(57) ABSTRACT

A method and devices to control global warming of the earth's environs are described. The method places devices in the form of particles, between the sun and the earth to block a portion of the solar radiation impinging on the earth. The devices comprise dispersed high effective surface area to weight ratio particles of various compositions and geometric shapes. In one embodiment, the devices are placed in earth orbit; in second embodiment, the particles are placed in a syncronis solar orbit. Blockage of a portion of the solar radiation directed toward the earth occurs via Rayleigh and Mie scattering, direct reflection and absorption.

This application claims the benefit of U.S. Provisional Patent Application No. 60/903,870 filed on Feb. 28, 2007.

### BACKGROUND OF THE INVENTION

Considerable scientific evidence has accumulated that abrupt changes in average temperatures over periods of time short in relation to the geologic time scale have occurred on the earth. These abrupt changes in average temperatures have had a dramatic impact upon the number and types of living things; in some cycles, the accompanying temperature changes have led to the extinction of a sizable portion of living animals and fauna. These abrupt changes take two forms, periods of rapid heating and periods of rapid cooling. On some occasions, the rapid heating is believed to result from geological activities such as volcanic eruptions where large amounts of volatile gases such as carbon dioxide, sulphur dioxide and sulphur trioxide are spewed into the atmosphere and, as a result, these gases trap a significant portion of the heat the earth typically radiates into space. Additionally, periods of rapid heating can result from massive lava flows covering hundreds or even thousands of square miles of the earth's surface.

In contrast, geologic events can also lead to rapid cooling, a classic example is believed to be that of a volcanic caldera called Toba in Indonesia. About 74,000 years ago, a rough circular portion of landscape of about thirty-five miles in diameter exploded in a volcanic eruption in a matter of a few minutes while hurdling hundreds of millions of tons of rock, stone and dust into the atmosphere. Many small particles remained suspended in the earth's atmosphere for several years which in turn significantly reduced the amount of sunlight reaching the earth's surface. It has been estimated that the average earth temperature dropped by about nine degrees due to this volcanic eruption.

Although the volcanic eruption of Toba of about 74,000 years ago was a natural event, human civilization has advanced to a point wherein during the last century hundreds of thousands of heavy manmade objects have been intentionally placed into the earth's atmosphere. Some examples include weather balloons, kites, gliders, helicopters, propeller and jet powered airplanes. Recently, human activities have even advanced to the point where thousands of objects have been placed into earth's orbit; objects such as missiles, navigation, weather and spy satellites, investigative craft such as the Hubble space telescope, space shuttles and the international space station. For example, to date, there have been one-hundred and sixteen space shuttle launches with the shuttle and its contents weighing 240,000 pounds on average, equivalent to 27,840,000 pounds total weight. Millions of pounds of materials put into earth orbit by human beings raises the possibility of employing this concept to eliminate, or at a minimum, control global warming.

Evidence is accumulating that the earth is currently in a period of rapidly, in a geological time frame, rising average worldwide temperature wherein the time span is brief in comparison to the geological time scale. This effect is commonly called global warming and is believed to be a result of two specific phenomena. The first effect results from natural events impacting the world's climate. The second phenomena believed to be contributing to global warming occurs as a result of human activity, related to power generation, heating, cooking, transportation, synthesis of materials, manufacturing, construction, agriculture and so forth which contribute to additional carbon dioxide (CO₂) gas, and other secondary gas emissions such as methane (CH₄), to the earth's atmosphere.

Solar radiation of various wavelengths reaching the earth heats the earth's surface and the heated earth surface responds by the earth's surface emitting infrared radiation back into space. The human generated carbon dioxide, CO₂, and secondary gases absorb additional amounts of the emitted infrared wavelengths, blocking a portion of heat radiation attempting to escape from the earth's atmosphere, thereby adding to the rapidly rising average temperature due to natural phenomena. This phenomena is commonly called the Greenhouse Effect. Thus, human activity on a worldwide basis is contributing directly to global warming. Even small changes to the amount of infrared radiation absorbed by the atmosphere can have long term effects on the earth's climate since the effect of the absorbed radiation accumulates over time. Quoting J. Pope, “How can Global Warming be Traced to CO₂?” Scientific American, Dec. 2, 2006 page 124 “The heating effect of extra carbon dioxide, methane, nitrous oxide and many other minor gases can be calculated with confidence based on properties that have been measured carefully in the lab. Currently the total heating produced by the increases of all such long-lived greenhouse gases (excluding water vapor) since pre-industrial times is equal to about 1 percent of all solar radiation absorbed at the surface. The effect would be somewhat similar if the sun had started to shine 1 percent more brightly during the 20^{th} century. That may sound trivial, but small changes in the earth's heat balance can lead to large climate changes—the ice ages a and the warmer periods in between during the past several million years appear to have been separated by global average temperature differences of only about five degrees Celsius in the tropics nd eight degrees C. in polar regions.” A good source of basic background information on Global Warming and possible methods of remediation can be found in a special issue of Scientific American, September 2006 entitled Energy's Future: Beyond Carbon which is enclosed herein in its entirety by reference.

If the published predictions and extrapolations about global warming are correct, then dramatic changes in the earth's climate over a short period of time, on a geological time scale, will result. These drastic changes will have a tremendous impact on human, animal and plant species, possibly leading to some or many extinctions, vast areas of the earth experiencing drought, flooding of coastal areas due to rising ocean levels, melting of the polar ice caps, and dramatic climatic and weather changes such as increased numbers and intensity of hurricanes and tornados.

Although numerous ideas, thoughts and suggestions are being discussed and published on how to eliminate, or at a minimum, reduce the contributions of human activities towards global warming, to date, each idea, thought or suggestion requires (a) tremendous investment in time and money, (b) long lengthy periods to implement, (C) world cooperation on a scale never before achieved and (d) worst of all, suffers from producing more CO₂ and secondary gases while implementation is underway. These ideas, suggestions and thoughts only at best can marginalize the contribution from human activities to Global Warming; they do not lessen the impact of the natural effect. In rare instances, ideas such as the sequestering of CO₂, both natural and that resulting from human activities have been suggested but the investment, time, manpower and cost are simply massive. Some specific references on various suggested methods can be found at Science & Technology/Climate, Wild Fixes for a Warming Planet pages 68 and 70, Business Week, Nov. 27, 2006 and The Trenton Times, Scientists say Pollution may be Earth 's Savior, page B1, Nov. 17, 2006 which are enclosed herein by reference.

There arises a need, therefore, to invent a method, devices and procedures to control Global Warming in regard to both contributing factors, i.e. those occurring naturally and those caused by human activity.

### SUMMARY OF THE INVENTION

It is the object of the present invention to provide a method and devices to control and/or eliminate global warming on a worldwide scale. The inventive method reduces the total heat input from the sun on the earth and as a consequence, (a) the average temperature of the earth is lowered and secondarily (b) less infrared radiation from a cooler earth is radiated back into the earth's atmosphere which results in less heat trapped in the earth's atmosphere. The method places numerous, well dispersed particles, i.e. devices, of various compositions, sizes, shapes and large effective surface areas to weight ratios in sun and/or earth orbit so that the orbiting particles scatter, reflect and absorb, electromagnetic radiation impinging on the earth from the sun. The scattering, reflection and absorption of solar electromagnetic radiation impinging on the earth reduces the overall heat imput from the sun onto the earth and thereby lessens or eliminates simultaneously a part of the heating effect due to natural and man-made causes.

### BRIEF DESCRIPTION OF THE FIGURES

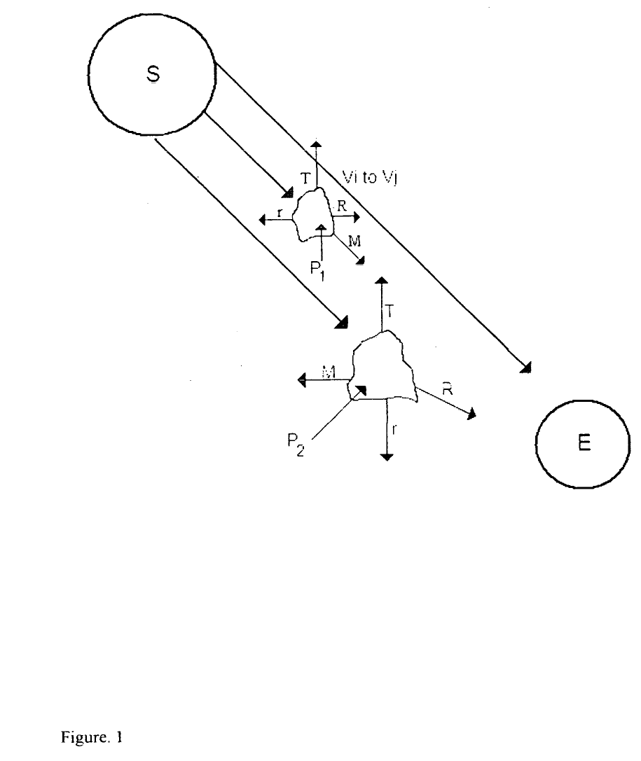

### FIG. 1

FIG. 1 illustrates various wavelengths, Vᵢ to Vⱼ, traveling from the sun S, to the earth, E, is scattering and reflected by a particle, P₂, in earth orbit before reaching the earth, see FIG. 1. Particle P₁ is in a solar orbit. The scattered radiation occurs via Rayleigh scattering, R, and Mie scattering, M; the reflected radiation is designated r in FIG. 1. The radiation absorbed, then readmitted, after a brief time delay into open space is labeled T.

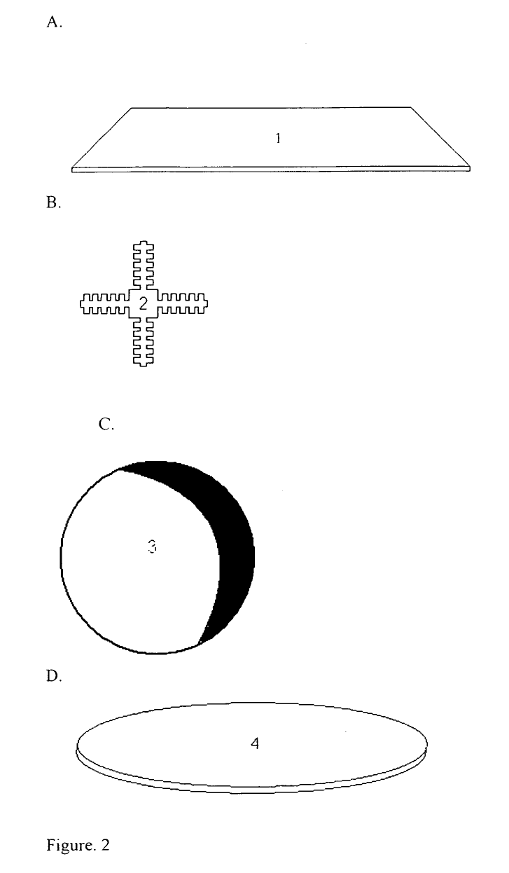

### FIG. 2

FIG. 2 illustrates examples of particle and geometric shape devices that can be employed to block solar radiation away from the surface of the earth. Shown in A is one (1) a sheet of paper like shape, in B is two (2), a snowflake like geometry; in C is three (3), a geometric sphere and in D is four (4), a disk.

### DETAILED DESCRIPTION OF THE INVENTION

The invention will now be described in connection with preferred embodiments. The embodiments are presented to aid in an understanding of the present invention and are not intended to, and should not be construed to, limit the invention in any way. All alternatives, modifications and equivalents that may become obvious to those of ordinary skill when reading the disclosure are included within the spirit and scope of the present invention.

The inventive method employs three distinct features which comprise dispersed particles in earth orbit block a portion of the sun's radiation impinging on the earth, thereby reducing the total heat imput to the earth, wherein the particles remain in orbit over extended periods of time thereby accruing a substantial heat loss, and the physical properties of the particles can be adjusted, altered and optimized to have greatest impact upon selected wavelength regions of the solar radiation impinging upon the earth.

In one embodiment, by placing particles, i.e. devices, in earth orbit, the devices reduce the sun's heating of the earth over extended periods of time, for example by years, decades or even centuries. The number, type, shape, size and placement of devices in orbit can be adjusted to achieve a desirable effect, for instance, to lessen heating in the northern or southern region of the earth, the particles can orbit in high northern or southern latitudes respectively. To reduce heating in the tropics, particles can be concentrated in orbit above the equator. Further, the altitude of orbit will effect the efficiency of radiation blockage and thus heat reduction of average earth temperature allowing for another form of adjustment to achieve a desired effect. Finally, particles can be placed in syncronis orbit to lessen the heating effect in a distinct region or area of the earth, for example, syncronis orbit over desert regions such as the Sahara or Gobi deserts.

In another embodiment, the devices, i.e. particles, are placed in syncronis orbit around the sun so that some portion of the solar radiation spectrum is blocked from reaching the earth. Even with conditions such that the orbital velocity needed to maintain syncronis sun orbit can lead to ever increasing orbital distances between the devices and the sun the effect over time is still cumulative leading to substantial reductions in solar radiation reaching the earth. In total, the method can employ any of these techniques or any and/or all in various combinations of the above described ideas.

By placing particles between the earth and the sun, the particles reduce the solar radiation impinging on the earth via three distinct processes. These processes are (1) by scattering of radiation wherein the major amount of reduction is due to Rayleigh Scattering and Mie Scattering; (2) by absorption of radiation then readmission after a time delay and (3) direct reflection of solar radiation off of a particle surface. The reduction in solar radiation traveling directly toward the earth by the processes in (1) and (3) above is due to the radiation traveling in all special directions after interacting with the particles, i.e. in a sphere of 360°. Further, the interaction in process (2) above directs a very large portion of the radiation away from the earth. The terms block and blockage are used to quantify the overall portion of solar radiation that is reduced in total by processes (1), (2) and (3) described directly above.

The actual portion of the solar radiation blocked by the devices is a complicated numerical calculation involving many variables. For instance, computations should include but are not limited to the geometric dimensions of the devices, device absorptivity, device reflexivity, orientation of the devices relative to the direction of the impinging solar radiation, altitude of orbit, solar spectrum profile, density of devices versus altitude and so forth. A simplified approximate measure of blockage can be employed; which is the ratio of the total effective surface area of all of the devices in orbit versus the cross sectional area of solar radiation impinging on the earth.

The above three described blocking effects depend in large part on physical properties of the devices themselves. The physical properties of the particles, i.e. devices, can be made of various compositions, different shapes, sizes, geometrics, surface area to weight ratios, additives can be used in combination with the basic particle composition to enhance absorption, the surface of the particles can be coated and/or reacted to enhance reflection and so forth. Further, the devices can be transparent or opaque to a portion or the entire solar radiation spectrum. Any or all of the physical properties can be used alone or in combination to achieve a sought blockage effect.

In this application, the term effective surface area describes the actual surface area of a particle that can interact with solar radiation at any given instant in time. The term total surface area describes the total surface area available over time for all the devices in orbit to interact with solar radiation. By way of illustration, the surface area of a sphere of radius r is described by the formula 4 πr²; at any given instant in time only one-half of the total surface area i.e. 2 πr² is available to interact since the remaining one-half of the total surface area is shaded by the sphere. Further, the effective surface area of a sphere is πr² since the solar radiation interacts with only a center cross section of the sphere.

Non-spherical devices also have an effective surface area different from the total surface area. The effective surface area needs to be calculated based on the non-spherical particles orientation over time with respect to the direction of solar radiation. By way of example, for a rectangular shaped particle of length, L, width, W, and thickness, T, the total surface area would be equal to 2×L×W+2×W×T+2×T×L. The effective surface area would be equal to the average between the largest and smallest dimension, i.e. ½(L×W+T×W) due to random tumbling motion of the particle in space over time.

In this application, the term particles, i.e. devices, is used to describe materials which exist in non-gaseous forms such as liquid droplets, glasses, crystalline solids, polymer chairs, thin films, sheets and so forth. A high effective surface area to weight ratio is desirable since it allows more particles per fixed weight and thus a larger effective surface area per fixed weight to be placed in orbit. The effective surface area to weight ratio should be about 10 m²/1 gram, preferably 25 m²/1 gram and most preferably be 50 m²/1 gram or higher. The effective surface to weight ratio quoted directly above are for dispersed particles in final form and in orbit and include openings, pores, void spaces, tunnels, cavities and so forth that occur naturally in the particles and/or have been incorporated by design and manufacture.

The particle size of a device should approximate the wave lengths of light selected to be blocked so that maximum efficiency of blockage of a selected wave length is achieved. The method incorporates flexibility so that mixtures of particle sizes, shapes and concentrations, distances in orbit and location can be employed and thus, the color of the sky as seen from earth can be adjusted, if so desired, to say mimic the natural color. Further, by selecting certain device characteristics to match selected wavelengths of solar radiation, the effect upon living systems, such as vegetation, can be enhanced or lessened by design.

A preferred embodiment is to employ materials with natural openings and/or manufactured openings within the material such as tunnels, chambers, void spaces, pores, cavities and so forth into the interior of the particles thereby increasing the effective surface area to weight ratio leading to increased blockage efficiency per unit weight.

The surface of the devices can be smooth, regular, dimpled, irregular, ridged, grooved and so forth to enhance or hinder the blockage of solar radiation of specific desired wavelengths. Further, the surface can be coated with a reflective material to allow specific wavelength portions of the solar radiation to be reflective back into open space. The chemical composition of the particles can be inorganic or organic. Some examples of inorganic materials include silicates, dioctahedral and trioctahedral layered silicates, feldspars, mica, talc, clays, vermiculite, thin metal films and foils, silica air foam and graphite. Some examples of organic materials include polyethylene, polypropylene, polystyrene, PVC, teflon, PTEN and polybutadieve. Further, the particles can be manufactured by a variety of chemical reactions and/or selected from naturally occurring materials.

In another embodiment, materials or additives to materials comprising the devices can be selected to provide beneficial effects to fauna and aqueous species on earth. For the process of placing devices in earth orbit, as the orbit of the device decays, the particles will either burn up in earth's atmosphere or fall back to earth. By selecting certain compositions of materials and/or additives, the fallen devices and/or decomposition products can function to provide fertilizers, additives, trace elements and so forth to living species on the earth's surface.

Mixtures of inorganics with inorganics, organics with organics and inorganics with organics within a particle or mixtures of say inorganic particles with organic particles are viable options.

Various chemical additives can be additives incorporated onto device surfaces or into the interior of the devices or can be naturally present. The presence of additives, such as transition metal complexes and/or dyes, can be employed to achieve specific effects, for example, the aqueous MnBr₄⁻ ion absorbs radiation primarily around 3600 A° with a weaker absorption near 4500 A° and thus the earth would receive less solar energy in these spectral regions. Further, the particles of the inventive method can contain additives or have additives incorporated to produce electrical or magnetic effects and/or to maintain desirable geometric shapes. By way of example, small grains of Magnetite, Fe₃O₄, allow for magnetization so that the particles could maintain certain orientations with respect to the earth's and/or sun's magnetic field while in orbit; thus, with proper alignment a non-spherical device can orient so that the device's effective surface area is perpendicular to the direction of the solar radiation increasing the effective surface area per unit weight.

The devices can be manufactured, processed, synthesized, developed and so forth on earth based facilities then placed in orbit and dispersed or these same steps can be carried out in orbit on the starting ingredients, then dispersed. A preferred method is earth based, then placed in orbit since a higher payload to launch weight ratio results.

The above described invented method and corresponding devices can be the only source to control global warming, can be used in conjunction with other techniques and methods or can be used to control global warming while alternative methods are being developed and implemented.

### EXAMPLE 1

This example illustrates an example of increase in effective surface area per unit weight that results from void spaces being present in a spherical device.

A solid sphere of 5000 Å in diameter (see FIG. 2B) has a volume of

Vₛ=4/3 πr³=4/3×(3.1416)×(2.5×10³ Å)³=65.45×10⁹(Å)³ and Å is in angstroms.

For a hollow sphere of 5000 Å having a wall thickness of 50 Å, the volume of the hollow sphere is

Vₕ=4/3 πr³=4/3(3.1416)×(2.450×10³ Å)³=61.60×10⁹(Å)³

and the volume of the solid portion is 65.45×10⁹(Å)³−61.60×10⁹(Å)³=3.85×10⁹ Å³

To achieve equal weights of 5000 Å³ spheres, solid and hollow, it requires

65.45×10⁹(Å)³ divided by 3.85×10⁹(Å)³=17

times as many spheres of hollow character; or for equal weights of 5000 Å spheres, solid vs. hollow, the hollow spheres will have seventeen times as much effective surface area.

### EXAMPLE 2

This example illustrates the comparison of the effective surface area to weight ratio of two devices of different geometric shapes.

From Example 1, the 5000 Å hollow sphere of 50 Å wall thickness had a volume of material of 3.85×10⁹(Å)³. The effective surface area of such a sphere for blocking solar radiation is S.A._{hs.}≈πr²=3.1416×(2500 Å)²=1.964×10⁷(Å)^{2.}

For a sheet of paper like device with volume equal to the hollow sphere, i.e. 3.85×10⁹(Å)³ where the length, L, the width, W, and the thickness, T, then the volume, V, equals L×W×T. Letting T=12.5 Å to mimic the thickness of a bentonite clay particle, if L=W, then L and W=17.55×10³ Å and the effective surface area available to block solar radiation of such a particle tumbling in space is (L×W+T×W)÷2=1.54×10⁸(Å)². For a magnetized particle, maintaining an orientation such that the largest component of the surface area is perpendicular to the direction of solar radiation, the effective surface area is 3.08×10⁸(Å)^{2.}The effective surface area ratio for non-magnetic sheet of paper like devices described above versus hollow spheres of 5000 Å and 50 Å in wall thickness in equal weight is 1.54×10⁸(Å)²÷1.964×10⁷(Å)²=7.85.

For a magnetically oriented particle of 12.5 Å in thickness, the effective surface area ratio is 3.08×10⁸(Å)²÷1.964×10⁷(Å)²=15.68.

### EXAMPLE 3

Part A of this experiment illustrates the potential total effective surface area achievable under the assumption that to date 40,000,000 pounds of objects have been launched into earth's orbit. Further, the chemical composition, void space, dimensions and additives to electrically charge the particles to maintain the largest surface area perpendicular to the solar radiation yields an effective surface area per weight of 500 m² per gram. Additionally, the devices are sheet of paper like devices with length of 7500 Å, width of 5000 Å and thickness of 20 Å.

For a payload to total weight of objects put into space of ratio equal to 0.8 the payload will weigh 32,000,000 pounds. In grams, 32,000,000 lbs.×453.6 g/lb.=1.452×10¹⁰ g. The total effective surface area is 500 m²/g×1.452×10¹⁰ g=7.26×10¹² m².

For Part B, it is assumed that the payload from Part A above is placed in a global orbit around the earth at an altitude of 250 miles. The cross sectional area of solar radiation traveling directly towards the earth and including the 250 mile orbit elevation yields a cross sectional diameter of 8000 miles+500 miles=8500 mile, and a cross sectional area of 3.1416×(4250 miles)²=5.675×10⁷ miles². There are 2.56×10⁶ m² in a square mile. Then 5.675×10⁷ miles²×2.56×10⁶ m²/mile=1.453×10¹⁴ m².

The ratio of total effective surface area of devices in earth orbit to the cross sectional area of direct solar radiation for devices in a 250 mile high orbit is 7.26×10¹² m²÷1.453×10¹⁴ m²=5×10⁻² or 5%. Therefore, at least 5% of the solar radiation traveling toward the earth of wavelengths between 5000 Å and 7500 Å are blocked.

### EXAMPLE 4

This example calculates the cumulative effect of the method and devices providing an initial 2.00% blockage in solar radiation over a 20 year period with 50% of the particles still in orbit at the 20 year point in time.

For a linear reduction in orbiting particles, then 2.0×0.5=1.0% still in orbit after 20 years. On average 2.0+1.0 divided by 2=1.5% average; 20 years×365 days=7300 total days. 7300 total days×1.5×10⁻²=109.5 equivalent days of total darkness with respect to the portion of solar radiation selected to be blocked within the total 20 year time span.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features herein before set forth and as follows in the scope of the claims.

What is claimed is:

1. A method to reduce the intensity of electromagnetic solar radiation impinging on the earth resulting in a reduction of the average earth temperature which comprises placing large surface area to weight ratio particles in earth orbit.

2. The method according to claim 1 wherein the particles are selected from silicates, dioctahedral and trioctahedral layered silicates, feldspars, mica, talc, clays, vermiculite, thin metal films and foils, silica air foam and graphite, polyethylene, polypropylene, polystyrene, PVC, teflon, PTEN, polybutadiene and mixtures thereof.

3. The method according to claim 2 wherein the particles have an effective surface area to weight ratio of particles from about 10 m²/g to 10,000 m²/g.

4. The method according to claim 3 wherein the particles have an average size of about 400 to about 7500 Angstroms.

5. The method according to claim 2 wherein the particles have an effective surface area to weight ratio of particles from about 25 m²/g to 10,000 m²/g.

6. The method according to claim 5 wherein the particles have an average size of about 400 to about 7500 Angstroms.

7. The method according to claim 2 wherein the particles have an effective surface area to weight ratio of particles from about 50 m²/g to 10,000 m²/g.

8. The method according to claim 7 wherein the particles have an average size of about 400 to about 7500 Angstroms.

9. The method according to claim 1 wherein the particles are electrically charge to interact with the earth's electron field.

10. The method according to claim 1 wherein the particles are magnetically charged to interact with the earth's magnetosphere.

11. The method according to claim 1 wherein the earth orbit is located at least 20 miles above the surface of the earth.

12. The method according to claim 1 wherein the earth orbit is syncronous.

13. The method according to claim 2 wherein the earth orbit is syncronous.

14. A method according to claim 1 wherein the average earth temperature is reduced by 0.1° C.

15. A method according to claim 1 wherein the average earth temperature is reduced by 0.2° C.

16. A method according to claim 1 wherein the average earth temperature is reduced by 0.5° C.

17. A method according to claim 1 wherein the particles contain chemical additives to absorb selective wavelengths of electromagnetic solar radiation.

18. A method according to claim 1 wherein the particle surfaces are coated with film to reflect electromagnetic solar radiation.
